(19) United States
(12) Patent Application Publication
(10) Pub. No.: US 2014/0263960 A1
(43) Pub. Date: Sep. 18, 2014

(54) SOLID-STATE IMAGING DEVICE

(71) Applicant: Kabushiki Kaisha Toshiba, Minato-ku (JP)

(72) Inventors: Yukiyasu TATSUZAWA, Yokohama-shi (JP); Keizo Tashiro, Yokohama-shi (JP); Tatsuji Ashitani, Yokohama-shi (JP); Motohiro Morisaki, Kawasaki-shi (JP)

(73) Assignee: Kabushiki Kaisha Toshiba, Minato-ku (JP)

(21) Appl. No.: 14/087,225

(22) Filed: Nov. 22, 2013

(30) Foreign Application Priority Data
Mar. 14, 2013 (JP) 2013-051592

(51) Int. Cl. H04N 5/353; H04N 5/378

(52) U.S. Cl. CPC H04N 5/3537; H04N 5/378
USPC 250/208.1

(57) ABSTRACT

According to one embodiment, a solid-state imaging device includes a pixel array, a digital gain circuit, and a shading correction circuit. In the pixel array, pixels that accumulate photoelectrically converted charge are arranged in a matrix and the pixel array can control an exposure time of the pixels for each line. The digital gain circuit adjusts a digital gain of an output signal of the pixel array. The shading correction circuit corrects shading of the pixel array by controlling the exposure time of the pixels and the digital gain.

### CROSS-REFERENCE TO RELATED APPLICATIONS

This application is based upon and claims the benefit of priority from Japanese Patent Application No. 2013-51592, filed on Mar. 14, 2013; the entire contents of which are incorporated herein by reference.

### FIELD

Embodiments described herein relate generally to a solid-state imaging device.

### BACKGROUND

In solid-state imaging devices, lens shading correction is performed to compensate for attenuation of the light intensity in the peripheral portion due to vignetting of the lens. To correct the lens shading, there is a method of setting the digital gain in the peripheral portion higher than the digital gain in the central portion.

### BRIEF DESCRIPTION OF THE DRAWINGS

FIG. 1 is a block diagram illustrating the schematic configuration of a solid-state imaging device according to an embodiment;

FIG. 2 is a block diagram illustrating the schematic configuration of a CMOS sensor in FIG. 1;

FIG. 3 is a circuit diagram illustrating a configuration example of a pixel in the CMOS sensor in FIG. 2;

FIG. 4 is a timing chart illustrating voltage waveforms in respective units in the pixel in FIG. 3 over a 1H period;

FIG. 5 is a diagram illustrating a reset timing of each line in a 1V period;

FIG. 6 is a diagram illustrating reset timings in a case where the exposure period in a portion E in FIG. 5 is changed;

FIG. 7A is a diagram illustrating the relationship between the vertical line No. and the digital gain in the solid-state imaging device in FIG. 1;

FIG. 7B is a diagram illustrating the relationship between the vertical line No. and the SNR when the digital gain in FIG. 7A is set;

FIG. 8A is a diagram illustrating the relationship between the vertical line No., the digital gain, and the exposure gain when the exposure time is 250H;

FIG. 8B is a diagram illustrating the relationship between the vertical line No., the digital gain, and the exposure gain when the exposure time is 0H;

FIG. 8C is a diagram illustrating the relationship between the vertical line No., the digital gain, and the exposure gain when the exposure time is 3H;

FIG. 8D is a diagram illustrating the relationship between the vertical line No., the digital gain, and the exposure gain when the exposure time is 1V;

FIG. 9A is a diagram illustrating the relationship between the exposure time and the number of synchronous reset lines when the reset timing for the exposure curve is 1 line step;

FIG. 9B is a diagram illustrating the relationship between the exposure time and the number of synchronous reset lines when the reset timing for the exposure curve is 2 line steps;

FIG. 9C is a diagram illustrating the reset timing of each line when the reset timing for the exposure curve is 1 line step;

FIG. 9D is a diagram illustrating the reset timing of each line when the reset timing for the exposure curve is 2 line steps;

FIG. 10A is a diagram illustrating the reset timing each line when the reset timing for the exposure curve is 4 line steps; and

FIG. 10B is a diagram illustrating the reset timing of each line when the reset timing for the exposure curve is 8 line steps.

### DETAILED DESCRIPTION

According to an embodiment, a solid-state imaging device includes a pixel array, a digital gain circuit, and a shading correction circuit. In the pixel array, pixels that accumulate photoelectrically converted charge are arranged in a matrix and the pixel array can control an exposure time of the pixels for each line. The digital gain circuit adjusts a digital gain of an output signal of the pixel array. The shading correction circuit corrects shading of the pixel array by controlling the exposure time of the pixels and the digital gain.

A solid-state imaging device according to an embodiment will be explained below in detail with reference to the accompanying drawings. The present invention is not limited to the following embodiment.

FIG. 1 is a block diagram illustrating the schematic configuration of a solid-state imaging device according to an embodiment.

In FIG. 1, the solid-state imaging device includes a CMOS sensor 11, a digital gain circuit 12, a ROM 13, and a shading correction circuit 14. The shading correction circuit 14 includes an exposure time calculating unit 14A, a gain information calculating unit 14B, and a number-of-line-steps setting unit 14C.

In the CMOS sensor 11, pixels that accumulate photoelectrically converted charge are arranged in a matrix. Moreover, the CMOS sensor 11 can control the exposure period of pixels for each line. The digital gain circuit 12 can adjust the digital gain of an output signal S1 from the CMOS sensor 11. The ROM 13 can store an ideal curve that indicates the relationship between a vertical line and the ideal gain necessary for ideally correcting shading of the CMOS sensor 11. The ideal curve can be represented by a function of cos⁴. The shading correction circuit 14 can correct shading of the CMOS sensor 11 by controlling the exposure period of pixels and the digital gain.

The exposure time calculating unit 14A can limit the exposure curve which indicates the relationship between the reset timing controlling the exposure period of pixels and the vertical lines to a predetermined curve and can calculate the exposure period of pixels such that shading of the CMOS sensor 11 can be corrected within the limitation. This exposure curve can be limited to, for example, a quadratic curve or a quartic curve. The gain information calculating unit 14B can calculate the digital gain such that the difference is compensated for between the exposure gain obtained on the basis of the exposure curve and the ideal gain indicated by the ideal curve. The number-of-line-steps setting unit 14C can set the number of line steps for the exposure curve such that number of vertical lines whose reset timings match is reduced.

In the shading correction circuit 14, the exposure period of pixels is calculated and the number of line steps for the exposure curve are set on the basis of an ideal curve S2 stored in the ROM 13, and they are output from the CMOS sensor 11 as exposure information S3. Moreover, in the shading correction circuit 14, the digital gain is calculated such that the difference is compensated for between the exposure gain obtained on the basis of the exposure curve and the ideal gain indicated by the ideal curve, and the calculated digital gain is output from the digital gain circuit 12 as gain information S4.

Then, in the CMOS sensor 11, the exposure period of pixels is controlled for each line and the number of line steps at the time of reset is set on the basis of the exposure information S3, and the output signal S1 at this point is output to the digital gain circuit 12. Then, in the digital gain circuit 12, the digital gain of the output signal S1 is adjusted such that the difference is compensated for between the exposure gain obtained on the basis of the exposure curve and the ideal gain indicated by the ideal curve, and the adjusted output signal S1 is output as a corrected output S5.

The difference between the exposure gain obtained on the basis of the exposure curve and the ideal gain indicated by the ideal curve is compensated for by using the digital gain; therefore, the SNR can be improved when compared with the case where lens shading correction is performed by using only the digital gain. Moreover, even in the case where the exposure time is short (for example, 1H=1 horizontal period) and the case where the exposure time is long (for example, 1V=1 vertical period), the lens shading correction accuracy can be improved by combining the exposure gain and the digital gain when compared with the case where lens shading correction is performed by using only the exposure gain. Furthermore, the exposure curve is limited to a predetermined curve; therefore, it is possible to estimate the timing at which a synchronous reset occurs. Therefore, the timings of the synchronous resets can be dispersed by setting the number of line steps in accordance with the exposure curve. Thus, the number of lines that cause a synchronous reset can be reduced, thereby enabling the load on the CMOS sensor 11 to be reduced.

FIG. 2 is a block diagram illustrating the schematic configuration of the CMOS sensor in FIG. 1.

In FIG. 2, the solid-state imaging device is provided with a pixel array unit 1. In the pixel array unit 1, pixels PC, which accumulate photoelectrically converted charge, are arranged in a matrix in a row direction RD and a column direction CD. Moreover, in the pixel array unit 1, horizontal control lines Hlin, which perform read control of the pixels PC, are provided in the row direction RD and vertical signal lines Vlin, which transmit signals read from the pixels PC, are provided in the column direction CD.

Moreover, the solid-state imaging device includes a vertical scanning circuit 2 that scans the pixels PC to be a read target in the vertical direction, a load circuit 3 that reads signals from the pixels PC for each column to the vertical signal line Vlin by performing a source follower operation with respect to the pixels PC, a column ADC circuit 4 that detects a signal component of each pixel PC in a CDS for each column, a horizontal scanning circuit 5 that scans the pixels PC to be a read target in the horizontal direction, a reference voltage generating circuit 6 that outputs a reference voltage VREF to the column ADC circuit 4, and a timing control circuit 7 that controls the read timing and charge accumulation timing of each pixel PC. A ramp wave can be used for the reference voltage VREF.

The timing control circuit 7 includes an exposure time control unit 7A. The exposure time control unit 7A includes an exposure reset-timing control unit 7B and a read timing control unit 7C. The exposure time control unit 7A controls the exposure period of the pixels PC for each line. The exposure reset-timing control unit 7B controls the reset timing of charge accumulated in the pixels PC of the pixel array unit 1. The read timing control unit 7C controls the read timing of charge accumulated in the pixels PC.

Then, the pixels PC in the row direction RD are selected by scanning the pixels PC in the vertical direction by the vertical scanning circuit 2. Then, the load circuit 3 performs a source follower operation with respect to the pixels PC, whereby signals read from the pixels PC are transmitted via the vertical signal line Vlin and sent to the column ADC circuit 4. Moreover, in the reference voltage generating circuit 6, a ramp wave is set as the reference voltage VREF and is sent to the column ADC circuit 4. Then, in the column ADC circuit 4, a count operation of counting a clock is performed until the signal level read from the pixels PC and the reset level match the level of the ramp wave, and the difference between the signal level and the reset level at this point is obtained, whereby the signal component of each pixel PC is detected in the CDS and is output as the output signal S1.

FIG. 3 is a circuit diagram illustrating a configuration example of a pixel in the CMOS sensor in FIG. 2.

In FIG. 3, in each pixel PC, a photodiode PD, a row select transistor Ta, an amplifying transistor Tb, a reset transistor Tc, and a read transistor Td are provided. A floating diffusion FD is formed as a detection node at a connection point of the amplifying transistor Tb, the reset transistor Tc, and the read transistor Td.

The source of the read transistor Td is connected to the photodiode PD and a read signal READ is input to the gate of the read transistor Td. Moreover, the source of the reset transistor Tc is connected to the drain of the read transistor Td, a reset signal RESET is input to the gate of the reset transistor Tc, and the drain of the reset transistor Tc is connected to a power supply potential VDD. Furthermore, a row selection signal ADRES is input to the gate of the row select transistor Ta, and the drain of the row select transistor Ta is connected to the power supply potential VDD. Moreover, the source of the amplifying transistor Tb is connected to the vertical signal line Vlin, the gate of the amplifying transistor Tb is connected to the drain of the read transistor Td, and the drain of the amplifying transistor Tb is connected to the source of the row select transistor Ta.

The horizontal control line Hlin in FIG. 2 can transmit the read signal READ, the reset signal RESET, and the row selection signal ADRES to the pixels PC for each row.

FIG. 4 is a timing chart illustrating voltage waveforms in respective units in the pixel in FIG. 3 over a 1H period.

In FIG. 4, when the row selection signal ADRES is at a low level, the row select transistor Ta is off; therefore, a pixel signal VSIG is not output to the vertical signal line Vlin. At this time, when the read signal READ and the reset signal RESET become a high level (ta1), the read transistor Td is turned on and the charge accumulated in the photodiode PD during a non-exposure period NX is discharged to the floating diffusion FD. Then, the charge is discharged to the power supply potential VDD via the reset transistor Tc.

After the charge accumulated in the photodiode PD during the non-exposure period NX is discharged to the power supply potential VDD, when the read signal READ becomes a low level, accumulation of effective signal charge is started in the photodiode PD so as to transition to an exposure period EX from the non-exposure period NX.

Next, when the row selection signal ADRES becomes a high level (ta2), the row select transistor Ta of the pixel PC is turned on and the power supply potential VDD is applied to the drain of the amplifying transistor Tb.

Then, when the reset signal RESET becomes a high level in a state where the row select transistor Ta is on (ta3), the reset transistor Tc is turned on and extra charge generated in the floating diffusion FD due to the leakage current or the like is reset. Then, a voltage in accordance with the reset level of the floating diffusion FD is applied to the gate of the amplifying transistor Tb, and the voltage of the vertical signal line Vlin follows the voltage applied to the gate of the amplifying transistor Tb, whereby the pixel signal VSIG at a reset level is output to the vertical signal line Vlin.

Then, the pixel signal VSIG at a reset level is input to the column ADC circuit 4 and is compared with the reference signal VREF. Then, the pixel signal VSIG at a reset level is converted to a digital value on the basis of the comparison result and is stored.

Next, when the read signal READ becomes a high level in a state where the row select transistor Ta is on (ta4), the read transistor Td is turned on and the charge accumulated in the photodiode PD during the exposure period EX is transferred to the floating diffusion FD. Then, a voltage in accordance with the signal read level of the floating diffusion FD is applied to the gate of the amplifying transistor Tb and the voltage of the vertical signal line Vlin follows the voltage applied to the gate of the amplifying transistor Tb, whereby the pixel signal VSIG at a signal read level is output to the vertical signal line Vlin.

Then, the pixel signal VSIG at a signal read level is input to the column ADC circuit 4 and is compared with the reference voltage VREF. Then, the difference between the pixel signal VSIG at a reset level and the pixel signal VSIG at a signal read level is converted to a digital value on the basis of the comparison result and the obtained digital value is output as the output signal S1 in accordance with a first exposure period FX1.

FIG. 5 is a diagram illustrating a reset timing of each line in a 1V period.

In FIG. 5, when the exposure period EX of each line is constant, an exposure curve TSA is represented by a straight line having a constant slope. Moreover, a read curve TR representing a read timing for each line is represented by a straight line having a constant slope. In contrast, when lens shading is corrected, an exposure curve TSB is set such that the exposure time is short in the central portion in the pixel array unit 1 and is long in the peripheral portion of the pixel array unit 1. The exposure curve TSB is limited to a predetermined curve, such as a quadratic curve or a quartic curve.

FIG. 6 is a diagram illustrating reset timings in a case where the exposure period in a portion E in FIG. 5 is changed.

In FIG. 6, the exposure curves TSB1 to TSB4 are such that the exposure time decreases toward the TSB4 from the TSB1. For the exposure curve TSB4 in which the exposure time is short, a synchronous reset does not occur; however, for the exposure curves TSB1 to TSB3 in which the exposure time is long, a synchronous reset occurs at times R1 to R6. The times R1 to R6 at which a synchronous reset occurs change depending on the exposure curves TSB1 to TSB3.

FIG. 7A is a diagram illustrating the relationship between the vertical line No. and the digital gain in the solid-state imaging device in FIG. 1, and FIG. 7B is a diagram illustrating the relationship between the vertical line No. and the SNR when the digital gain in FIG. 7A is set.

In FIG. 7A, for example, if an exposure curve LG2 is a curve that is limited to a quartic curve, because an ideal curve LG1 is represented by a function of cos⁴, deviation occurs between the exposure curve LG2 and the ideal curve LG1.

Moreover, in FIG. 7B, if the SNR for each vertical line No. before lens shading correction is represented by LS1, the SNR for each vertical line No. when lens shading is corrected in accordance with the exposure curve LG2 is represented by LS2. At this time, because deviation occurs between the exposure curve LG2 and the ideal curve LG1, the improvement factor of the SNR changes depending on the vertical line No.

FIG. 8A is a diagram illustrating the relationship between the vertical line No., the digital gain, and the exposure gain when the exposure time is 250H, FIG. 8B is a diagram illustrating the relationship between the vertical line No., the digital gain, and the exposure gain when the exposure time is 0H, FIG. 8C is a diagram illustrating the relationship between the vertical line No., the digital gain, and the exposure gain when the exposure time is 3H, and FIG. 8D is a diagram illustrating the relationship between the vertical line No., the digital gain, and the exposure gain when the exposure time is 1V. In FIG. 8A to FIG. 8D, the exposure curve is limited to a quartic curve as an example.

In FIG. 8A, when the exposure time is 250H, the exposure time can be changed every vertical line in 249 steps. Therefore, the exposure gain EG1 can be finely set for each vertical line. Thus, even if the exposure curve is limited to a quartic curve, the deviation between the ideal gain TG1 and the exposure gain EG1 can be reduced. Moreover, the difference between the ideal gain TG1 and the exposure gain EG1 can be compensated for by adjusting the digital gain DG1.

In FIG. 8B, when the exposure time is 0H, the exposure time cannot be changed every vertical line. Therefore, the exposure gain EG2 becomes constant. Thus, the digital gain DG2 needs to be made equal to the ideal gain TG2 in order to correct lens shading.

In FIG. 8C, when the exposure time is 3H, the exposure time can be changed every vertical line only in two steps. Therefore, the deviation between the ideal gain TG3 and the exposure gain EG3 increases. At this time, the difference between the ideal gain TG3 and the exposure gain EG3 can be compensated for by adjusting the digital gain DG3.

In FIG. 8D, when the exposure time is 1V, the exposure time cannot be changed every vertical line. Therefore, the exposure gain EG4 becomes constant. Thus, the digital gain DG4 needs to be made equal to the ideal gain TG4 in order to correct lens shading.

FIG. 9A is a diagram illustrating the relationship between the exposure time and the number of synchronous reset lines when the reset timing for the exposure curve is 1 line step, FIG. 9B is a diagram illustrating the relationship between the exposure time and the number of synchronous reset lines when the reset timing for the exposure curve is 2 line steps, FIG. 9C is a diagram illustrating the reset timing of each line when the reset timing for the exposure curve is 1 line step, and FIG. 9D is a diagram illustrating the reset timing of each line when the reset timing for the exposure curve is 2 line steps.

In FIG. 9A and FIG. 9B, when the reset timing for the exposure curve is increased from 1 line step to 2 line steps, it is seen that the number of lines in which a synchronous reset occurs is reduced.

At this time, as illustrated in FIG. 9C and FIG. 9D, when the reset timing for the exposure curve is increased from 1 line step to 2 line steps, the exposure curve is folded in a zigzag manner in the time direction and the lines in which a synchronous reset occurs are dispersed in the time direction.

FIG. 10A is a diagram illustrating the reset timing of each line when the reset timing for the exposure curve is 4 line steps, and FIG. 10B is a diagram illustrating the reset timing of each line when the reset timing for the exposure curve is 8 line steps.

In FIG. 10A and FIG. 10B, when the number of line steps of the reset timing for the exposure curve is further increased, the exposure curve is folded in a zigzag manner in the time direction with a larger amplitude; therefore, the lines in which a synchronous reset occurs are dispersed in the time direction. Thus, the number of lines in which a synchronous reset occurs can be reduced by selecting the number of line steps in accordance with the exposure curve used when lens shading is corrected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array in which pixels that accumulate photoelectrically converted charge are arranged in a matrix and which is capable of controlling an exposure time of the pixels for each line;
a digital gain circuit that adjusts a digital gain of an output signal of the pixel array; and
a shading correction circuit that corrects shading of the pixel array by controlling the exposure time of the pixels and the digital gain.

2. The solid-state imaging device according to claim 1, wherein an exposure curve which indicates a relationship between a reset timing controlling the exposure time of the pixels and a vertical line is limited to a predetermined curve.

3. The solid-state imaging device according to claim 2, wherein in a state where the exposure curve is limited to the predetermined curve, the digital gain is controlled such that it approaches an ideal gain necessary for ideally correcting shading of the pixel array.

4. The solid-state imaging device according to claim 3, wherein a difference between an exposure gain obtained on a basis of the exposure curve and the ideal gain is compensated for by the digital gain.

5. The solid-state imaging device according to claim 4, further comprising a memory in which an ideal curve that indicates a relationship between the ideal gain and the vertical line is registered.

6. The solid-state imaging device according to claim 5, wherein the exposure curve is a quadratic curve or a quartic curve.

7. The solid-state imaging device according to claim 5, wherein the ideal curve is preset such that attenuation of a light intensity in a peripheral portion of the pixel array due to vignetting of a lens is compensated for.

8. The solid-state imaging device according to claim 7, wherein the ideal curve is represented by a function of cos⁴.

9. The solid-state imaging device according to claim 1, wherein the exposure time is changed stepwise every vertical line.

10. The solid-state imaging device according to claim 9, wherein the exposure time is changed every horizontal period.

11. The solid-state imaging device according to claim 2, wherein
the shading correction circuit includes
an exposure time calculating unit that limits an exposure curve which indicates a relationship between a reset timing controlling the exposure time of the pixels and a vertical line to a predetermined curve and calculates the exposure time of the pixels such that shading of the pixel array is corrected within the limitation, and
a gain information calculating unit that calculates the digital gain such that a difference is compensated for between an exposure gain obtained on a basis of the exposure curve and an ideal gain indicated by the ideal curve.

12. The solid-state imaging device according to claim 4, further comprising:
an exposure reset-timing control unit that controls a reset timing of charge accumulated in the pixels of the pixel array; and
a read timing control unit that controls a read timing of charge accumulated in the pixels.

13. The solid-state imaging device according to claim 5, further comprising:
a vertical scanning circuit that scans a pixel that is a read target in a vertical direction;
a horizontal scanning circuit that scans a pixel that is a read target in a horizontal direction;
a load circuit that reads a signal from the pixel to a vertical signal line for each column by performing a source follower operation with respect to the pixel;
a column ADC circuit that detects a signal component of each of the pixels in a CDS for each column; and
a reference voltage generating circuit that outputs a reference voltage to the column ADC circuit.

14. The solid-state imaging device according to claim 6, wherein
the pixel includes
a photodiode that performs photoelectric conversion,
a detection node that receives charge accumulated in the photodiode,
a read transistor that reads charge accumulated in the photodiode to the detection node,
an amplifying transistor that converts charge received by the detection node to a voltage, and
a reset transistor that resets the detection node.

15. The solid-state imaging device according to claim 1, wherein the shading correction circuit includes a number-of-line-steps setting unit that sets number of line steps for the exposure curve.

16. The solid-state imaging device according to claim 15, wherein the number-of-line-steps setting unit sets number of line steps for the exposure curve such that number of vertical lines whose reset timings match is reduced.

17. The solid-state imaging device according to claim 1, wherein
the shading correction circuit includes
an exposure time calculating unit that limits an exposure curve which indicates a relationship between a reset timing controlling the exposure time of the pixels and a vertical line to a predetermined curve and calculates the exposure time of the pixels such that shading of the pixel array is corrected within the limitation,
a gain information calculating unit that calculates the digital gain such that a difference is compensated for between an exposure gain obtained on a basis of the exposure curve and an ideal gain necessary for ideally correcting shading of the pixel array, and
a number-of-line-steps setting unit that sets number of line steps for the exposure curve.

18. The solid-state imaging device according to claim 17, wherein the number-of-line-steps setting unit sets number of line steps for the exposure curve such that number of vertical lines whose reset timings match is reduced.

19. The solid-state imaging device according to claim 1, further comprising:
an exposure reset-timing control unit that controls a reset timing of charge accumulated in the pixels of the pixel array; and
a read timing control unit that controls a read timing of charge accumulated in the pixels.

20. The solid-state imaging device according to claim 1, further comprising:
a vertical scanning circuit that scans a pixel that is a read target in a vertical direction;
a horizontal scanning circuit that scans a pixel that is a read target in a horizontal direction;
a load circuit that reads a signal from the pixel to a vertical signal line for each column by performing a source follower operation with respect to the pixel;
a column ADC circuit that detects a signal component of each of the pixels in a CDS for each column; and
a reference voltage generating circuit that outputs a reference voltage to the column ADC circuit.
